(19) United States
(12) Patent Application Publication
(10) Pub. No.: US 2026/0145788 A1
(43) Pub. Date: May 28, 2026

(54) HELICOPTER TAIL BOOM AND METHODS OF MANUFACTURE AND RETROFIT OF SAME

(71) Applicant: BLR Aerospace, L.L.C., Everett, WA (US)

(72) Inventor: Andrew D. Graham, Edmonds, WA (US)

(21) Appl. No.: 19/397,632

(22) Filed: Nov. 21, 2025

Related U.S. Application Data
(60) Provisional application No. 63/724,174, filed on Nov. 22, 2024.

(51) Int. Cl. B64C 27/82; B64C 27/04

(52) U.S. Cl. CPC B64C 27/82; B64C 27/04; B64C 2027/8263

(57) ABSTRACT

Disclosed herein are components, systems, and methods to improve directional control of an aircraft in various flight conditions. A tail boom may have a cross-sectional shape including a chord that is angularly offset from a vertical axis of the aircraft. A method of retrofitting a tail boom of an aircraft includes changing a cross-sectional shape of the tail boom thereby altering a chord of the tail boom such that when the tail boom is mounted to the aircraft the altered chord is angularly offset from a vertical axis of the aircraft about which one or more main rotor blades rotate to generate lift for the aircraft.

### BACKGROUND

This disclosure relates to helicopters with tail rotors, and more particularly, to tail booms of said helicopters that generate anti-torque from airflow over the tail boom to improve directional control of said helicopters.

Helicopters are able to hover in flight, maneuver in any direction, and land in remote environments. These abilities provide a significant value to an operator of a helicopter that enable performance not achievable with other types of aircraft. Helicopters with a single, main rotor are the most popular and abundant. These single, main rotor helicopters typically utilize a tail rotor (or equivalent functioning device) to provide sufficient anti-torque to balance positive and negative torque generated by the main rotor. The tail rotor provides directional control of the aircraft in all modes of flight. Early helicopters used a simple, light-weight truss design to support the tail rotor. As helicopter designs matured, the trusses were enclosed to reduce parasitic drag of the open truss design. Traditionally, the enclosures have been symmetrical and designed to optimize “forward” flight of the helicopter.

When operating near objects such as trees, mountain ridges, power lines, etc., especially when proximate a landing zone, the ability to control the orientation of the helicopter regardless of the wind direction is important. Orientation control impacts the ability to land or perform desired functions and ultimately the safety of the aircraft and its occupants. Known tail boom shapes, such as the BLR FastFin© tail boom and those described in U.S. Pat. No. 10,279,899 issued on May 7, 2019, and U.S. Pat. No. 11,447,243 issued on Sep. 20, 2022, the entireties of which are both incorporated herein by reference, are designed to optimize hover flight characteristics and provide reduced to no benefit when wind is affecting the aircraft.

The amount of thrust a tail rotor can produce is finite. Accordingly, if the amount of anti-torque generated is insufficient to offset the main rotor torque and the winds affecting the aircraft, the aircraft's value to its operator may be limited. In addition, there are regulatory compliance requirements to show that an aircraft is controllable within an approved flight envelope while under powered and unpowered flight.

Thus, a need exists for tail booms, and kits to retrofit existing tail booms, that improve flight characteristics of an aircraft when hovering in crosswind conditions, while minimizing impact on other important flight conditions and either improving or remaining neutral regarding efficiency of the aircraft to which the tail booms are attached.

### BRIEF SUMMARY

Embodiments described herein include a tail boom with a shape that utilizes downwash from a main rotor of an aircraft to improve hover performance and directional control capability with wind from any azimuth (referred to herein as “low speed control”). These tail booms may improve both the safety of the aircraft on which they are installed (e.g., from loss of tail rotor effectiveness (LTE)) and the amount of weight the aircraft is capable of carrying.

Some embodiments of the tail boom described herein include a leading edge position and shape that generate a pressure differential on opposite sides of the tail boom. This pressure differential reduces anti-torque resulting from large changes in down wash angle associated with various powered flight conditions and wind. Additionally, when an aircraft is in autorotation (from engine failure or simulated engine failure) or forward flight, some embodiments of the tail boom described herein may be equivalent to or better than known symmetrical tail boom shapes.

Referring to FIGS. 1 and 2, embodiments of a tail boom 150 for an aircraft 100 described herein may include a cross-sectional shape formed by an outer perimeter of a body of the tail boom 150. Reference planes as described herein include a plane P1, a plane P2 that is perpendicular to the plane P1, and a plane P3 that is perpendicular to both the plane P1 and the plane P2. The plane P1 extends along an x-axis, which is parallel to a length of an aircraft 100 that extends from a nose 101 of the aircraft to a tail 103 of the aircraft 100, and further extends along a z-axis, which is parallel to a height of the aircraft 100 that extends parallel to an axis of rotation 108 of a main rotor 102 of the aircraft 100. The plane P2 extends along a y-axis, which is parallel to a width of an aircraft 100 that is perpendicular to the length and the height of the aircraft 100, and further extends along the z-axis. The plane P3 extends along the x-axis and further extends along the y-axis.

An entirety of the cross-sectional shape may be within a plane P2, and the cross-sectional shape may include a chord. The tail boom 150 may be secured to the aircraft 100 such that a chord of the tail boom is angularly offset from the plane P1. The plane P1 and the plane P2 may be parallel to and intersect at the axis of rotation 108 of the main rotor 102 of the aircraft 100 about which one or more main rotor blades 106 rotate to generate lift for the aircraft 100.

Additional embodiments disclosed herein include an aircraft including a main rotor, a tail rotor, and the tail boom described above. The main rotor rotates about a first axis of rotation to rotate one or more main rotor blades to generate lift for the aircraft. The tail rotor rotates about a second axis of rotation to rotate one or more tail rotor blades to generate thrust that counters torque generated by the rotation of the main rotor about the first axis of rotation. The tail boom is positioned between the main rotor and the tail rotor.

A method of retrofitting a tail boom of an aircraft includes changing a cross-sectional shape of the tail boom. The cross-sectional shape is formed by an outer perimeter of a body of the tail boom within a plane parallel to the plane P2. Changing the cross-sectional shape includes altering a chord of the tail boom such that when the tail boom is mounted to the aircraft the altered chord is angularly offset from the plane P1.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings. The headings and Abstract of the Disclosure provided herein are for convenience only and do not interpret the scope or meaning of the embodiments.

FIG. 1 is a top plan view of an aircraft with reference planes identified.

FIG. 2 is a side elevation view of an aircraft with reference planes identified.

FIG. 3 is a top plan view of an aircraft showing torque applied by a main rotor of the aircraft and thrust applied by a tail rotor of the aircraft when the aircraft is under power.

FIG. 4 is a top plan view of the aircraft illustrated in FIG. 1, showing torque applied by the main rotor and thrust applied by the tail rotor when the aircraft is in autorotation.

FIG. 5 is a side elevation view of the aircraft in FIG. 1, showing airflow through the main rotor when the aircraft is under power.

FIG. 6 is a side elevation view of the aircraft in FIG. 5, showing airflow through the main rotor when the aircraft is in autorotation.

FIG. 7 is a top plan view of an aircraft showing the critical wind azimuth, according to one embodiment.

FIG. 8 is a cross-sectional, schematic view of a known tail boom of an aircraft showing torque applied to the aircraft and anti-torque needed by and generated by the tail boom and a tail rotor when the aircraft is hovering.

FIG. 9 is a cross-sectional, schematic view of the known tail boom illustrated in FIG. 8 showing torque applied to the aircraft and anti-torque needed by and generated by the tail boom and the tail rotor when the aircraft is impacted by a critical crosswind.

FIG. 10 is a cross-sectional, schematic view of a tail boom of an aircraft according to an embodiment of the disclosure showing anti-torque generated by the tail boom when the aircraft is hovering.

FIG. 11 is a cross-sectional, schematic view of the tail boom illustrated in FIG. 10 showing anti-torque generated by the tail boom when the aircraft is impacted by a critical crosswind.

FIG. 12 is a cross-sectional, schematic view of the tail boom illustrated in FIG. 10 showing anti-torque generated by the tail boom when the aircraft is under power.

FIG. 13 is a cross-sectional, schematic view of the tail boom illustrated in FIG. 10 showing anti-torque generated by the tail boom when the aircraft is in autorotation.

FIG. 14 is a cross-sectional, schematic view of the tail boom illustrated in FIG. 10 showing the tail boom chord, an angle of attack measured from the chord to an airflow direction typical during hover, and a tail boom pitch measured from the chord to a vertical axis of the aircraft.

FIG. 15 is a cross-sectional, schematic view of the tail boom illustrated in FIG. 14 showing the tail boom chord, the angle of attack, and the tail boom pitch when the aircraft is in a crosswind coming from an approaching blade side of the tail boom.

FIG. 16 is a cross-sectional, schematic view of the tail boom illustrated in FIG. 14 showing the tail boom chord, the angle of attack, and the tail boom pitch when the aircraft is in a crosswind coming from a retreating blade side of the tail boom.

FIG. 17 is a graph plotting a lift curve depicting an optimum angle of attack for a tail boom for an aircraft in hover.

FIG. 18 is a graph plotting a lift curve depicting the combination of the optimum angle of attack for hover, wind from the retreating side and wind coming from the approaching side for an embodiment of a tail boom of the disclosure for an aircraft in crosswind.

FIG. 19 is a graph plotting a lift curve depicting the combination of the optimum angle of attack for a hover condition, wind from the retreating side and wind coming from the approaching side for an embodiment of a known tail boom in crosswind.

FIG. 20 is a graph plotting a lift curve depicting the combination of the optimum angle of attack for hover, wind from the retreating side and wind coming from the approaching side for an embodiment of a tail boom in crosswind.

FIG. 21 is a cross-sectional, schematic view of a tail boom showing an optimum angle of attack in a hover condition.

FIG. 22 is a graph plotting a lift curve depicting the combination of the optimum angle of attack for a hover condition for the tail boom illustrated in FIG. 21.

FIG. 23 is a pressure plot for a cross-sectional shape of a tail boom, according to one embodiment.

FIG. 24 is a pressure plot for a cross-sectional shape of a tail boom, according to another embodiment.

FIG. 25 is a pressure plot for a cross-sectional shape of a tail boom, according to another embodiment.

FIG. 26 is a cross-sectional view of a conversion of a tail boom, according to another embodiment.

### DETAILED DESCRIPTION

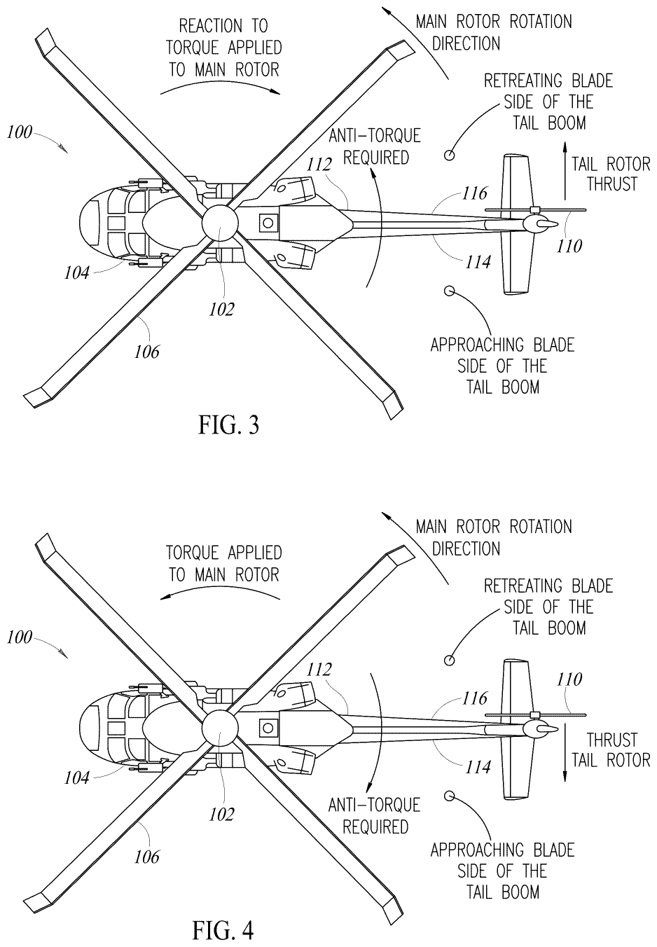

Referring to FIGS. 3 and 4, an aircraft 100 (e.g., a helicopter) includes an engine (not shown) that drives a main rotor 102, which rotates relative to a body 104 of the aircraft 100. Rotation of the main rotor 102, which includes main rotor blades 106, generates lift which enables the aircraft 100 to fly. As shown in FIG. 3, the engine applies a torque to the main rotor 102 resulting in the rotation of the main rotor 102 and the main rotor blades 106 about an axis of rotation 108. As shown in FIG. 4, if the aircraft 100 loses engine power, the aircraft 100 may transition to an autorotation flight mode.

In autorotation, the engine may be disengaged from the main rotor 102, and the main rotor 102 may apply a torque to the body 104. This torque may be applied due to rotation of the main rotor blades 106 caused by movement of air up through the main rotor blades 106 as the aircraft 100 falls. The torque may be stored as kinetic energy for use in an emergency landing. To counter act the torques described above, an anti-torque is generated by a tail rotor 110 of the aircraft 100. The anti-torque may be applied to the aircraft 100 via pilot input (e.g., through rudder pedals).

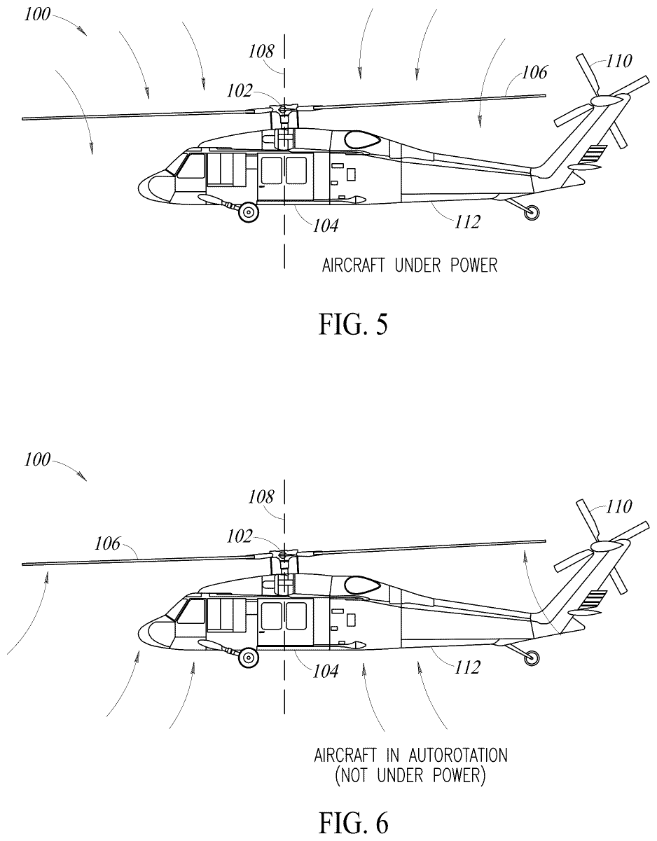

Referring to FIGS. 5 and 6, the main rotor blades 106 may pass above a tail boom 112 of the aircraft 100 that supports the tail rotor 110, as shown. The tail boom 112 may be shaped to generate a pressure differential (e.g., with a higher pressure on an approaching side 114 of the tail boom 112, which the main rotor blades 106 approach during powered flight, and a lower pressure on a retreating side 116 of the tail boom 112, which the main rotor blades 106 retreat from during powered flight) to generate beneficial torque during powered flight. The pressure differential may be reversed (e.g., with a higher pressure on the retreating side 116 and a lower pressure on the approaching side) when the aircraft 100 is in autorotation.

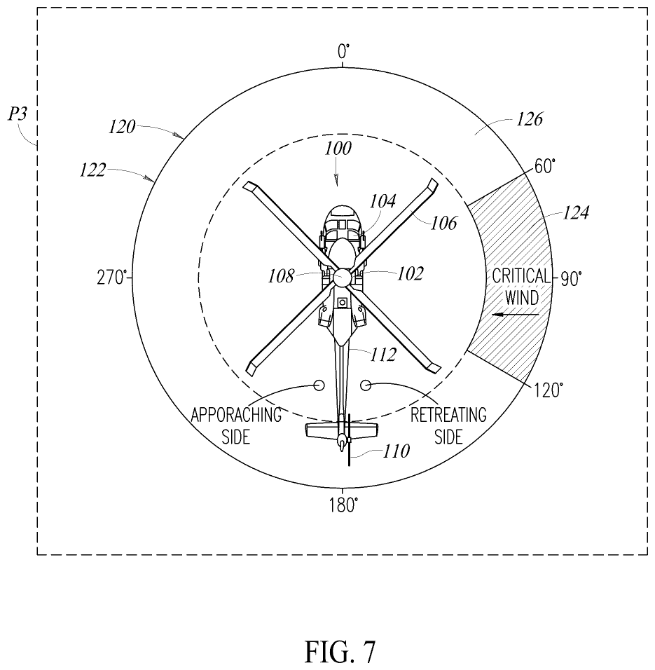

Referring to FIG. 7, a wind direction diagram 120 defines a 360 degree perimeter 122 about the aircraft 100. As shown, the 360 degree perimeter 122 may be located within a plane P3, which may be normal to the axis of rotation 108 of the main rotor 102. The wind direction diagram 120 illustrates a critical wind azimuth zone 124, which includes a portion of the 360 degree perimeter 122 in which the aircraft's maximum operable wind speed is reduced compared to a non-critical wind azimuth zone 126 (e.g., which includes a remainder of the 360 degree perimeter).

Wind that approaches an aircraft from within the critical wind azimuth zone 124 acts on (e.g., exerts a pressure against) a large portion of the aircraft (e.g., up to an entire side of the aircraft, including a passenger cabin, cargo area, tail boom, tail, and engine compartment). Most helicopters have a vertical tail/tail boom (e.g., elongated parallel to the plane P1) to provide directional stability and anti-torque in forward flight. These vertical tail booms reduce the amount of power required to drive the tail rotor 110 as forward speed increases.

In addition, helicopters often have external equipment that can be added, such as cargo baskets, cameras, lights, speakers, etc. that affect the wind flowing over the aircraft 100. The shapes of the aircraft 100 (including any of its external equipment) and direction that the wind approaches from, may affect the amount of anti-torque that needs to be generated by the thrust of the tail rotor 110 for acceptable directional control of the aircraft 100. The aerodynamic forces acting on each of the surfaces of the aircraft 100 are multiplied by a distance between the axis of rotation 108 of the main rotor 102 and an aerodynamic center of pressure for each of the respective surfaces to determine the resultant moment. Adding up all of the moments around the main rotor 102 equates to an increase or decrease of the amount of anti-torque generated by the aircraft 100. The combined aerodynamic impact of the entire aircraft 100, including forces applied by the approaching wind, plus the anti-torque required to turn the main rotor 102 must be balanced by the tail rotor 110.

The maximum wind speed the aircraft 100 can experience while maintaining directional control may vary based on the direction from which the wind is approaching. For example, the critical wind azimuth zone 124 may be between 60 degrees and 120 degrees of the 360 degree perimeter 122. As shown in the illustrated embodiment, the aircraft 100 may be able to maintain directional control at its maximum operational weight when wind from a direction within the critical wind azimuth zone 124 is less than or equal to 10 kts, while being able to maintain directional control at its maximum operational weight when wind from a direction within the non-critical wind azimuth zone 126 is up to 17 kts.

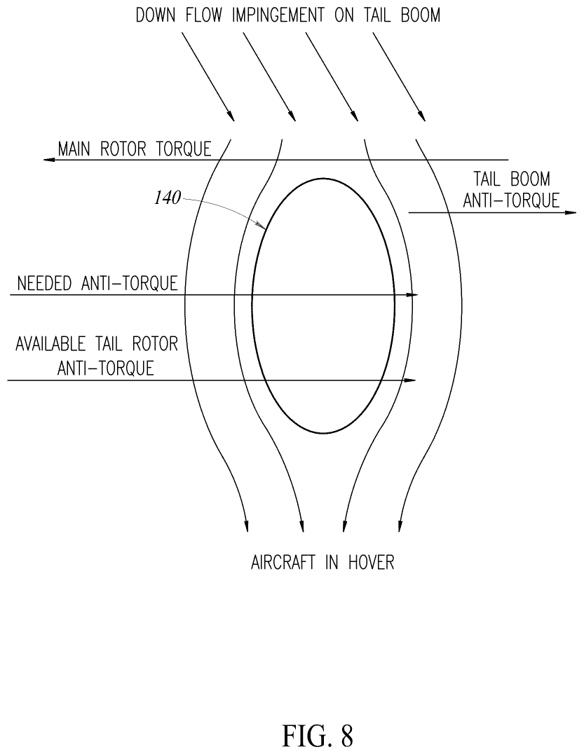

Referring to FIG. 8, a known tail boom 140 of a helicopter produces a small amount of anti-torque when hovering. The anti-torque may be generated by the direction of flow (e.g., a flow angle) of the downwash from a main rotor of the helicopter. This anti-torque assists the anti-torque generated by a tail rotor of the helicopter in balancing the torque generated by the main rotor.

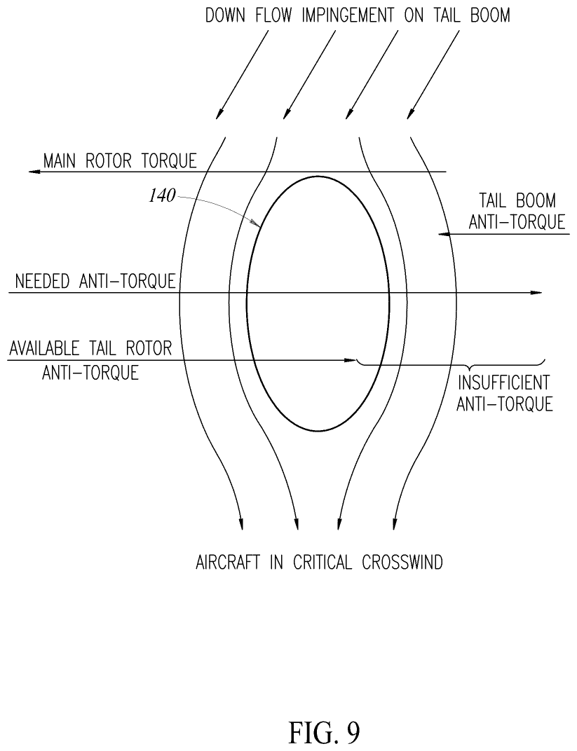

Referring to FIG. 9, when the helicopter is in a cross-flow condition (e.g., with wind approaching the aircraft from the critical wind azimuth zone or the retreating blade side of the tail boom), the shape of the known tail boom 140 applies a torque in the opposite direction of the needed anti-torque. Instead of helping the tail rotor by generating anti-torque that acts in the opposite direction of the torque of the main rotor, the anti-torque generated by the known tail boom 140 adds to the torque applied by the main rotor. This combination of torques quickly exceeds the maximum capability of the tail rotor to adequately counter it as needed to maintain directional control.

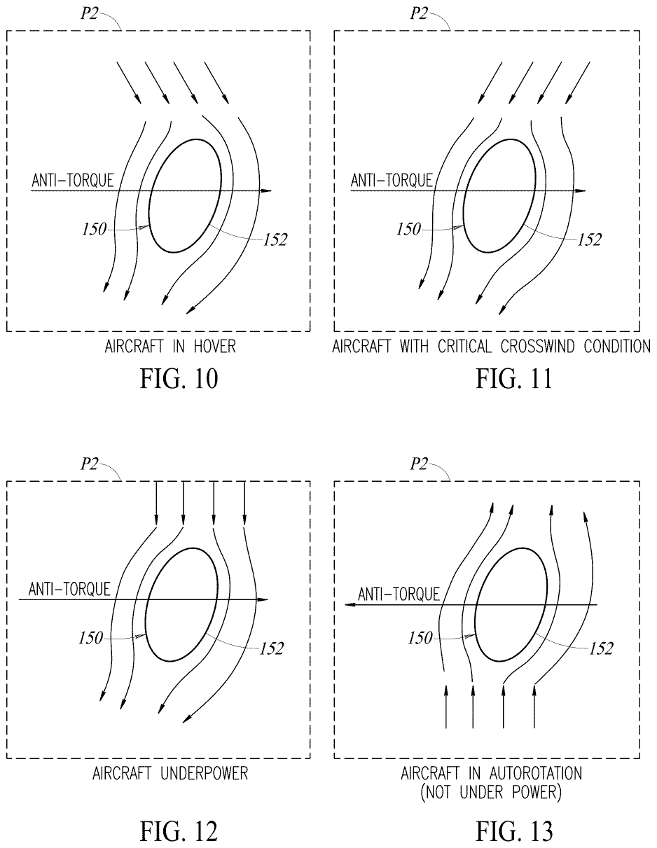

Referring to FIGS. 10 and 11, a tail boom 150 of an aircraft (e.g., the aircraft 100, which may be a helicopter) may improve the performance of the aircraft to which it is attached in hover and crosswind conditions. As shown in FIG. 10, the tail boom 150 may have a shape that increases (e.g., maximize) an impingement angle when the aircraft is hovering without causing airflow separation on a side 152 of the tail boom 150 with a lower applied pressure. As shown in FIG. 11, the tail boom 150 may also reduce (e.g., eliminate) the amount of torque generated by the tail boom 150 that acts in the same direction as the main rotor 102 when the aircraft 100 is in a crosswind condition (e.g., wind approaching the aircraft 100 from the critical wind azimuth zone 124).

Referring to FIGS. 12 and 13, the tail boom 150 may also provide the improved performance described above in both powered (e.g., when the engine rotates the main rotor 102) and unpowered (e.g., autorotation) conditions. During autorotation, “reverse” anti-torque is desired to counter torque applied to the main rotor blades by the upward flow of air. Maximizing the amount of “reverse” anti-torque applied by the tail boom 150 helps maintain the rotational inertial energy of the main rotor and gearboxes for a safe landing flare.

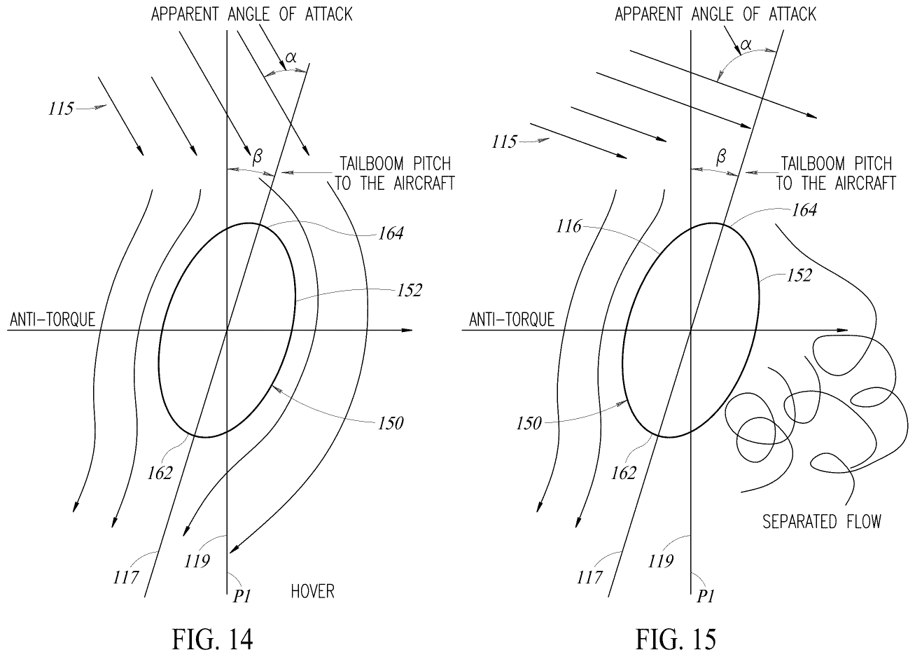

Referring to FIGS. 14 to 16, the tail boom 150 may include an aerodynamic apparent angle of attack α measured from a direction of the airflow 115 to a chord 117 of the tail boom 150. The chord 117 may be described as a straight line that passes through both a leading edge (e.g., an apex, a frontmost point that first meets air) and a trailing edge (e.g., an apex, where airflow from upper and lower or opposite sides of the tail boom 150 meet) of the tail boom 150. The direction of the airflow 115 may include a combination of downwash from the main rotor 102 and any wind/crosswind impacting the aircraft 100.

According to some embodiments, the direction of the airflow 115 ignores wind/drag generated by the forward movement of the aircraft 100. The chord 117 is a function of the shape of the tail boom 150. The tail boom 150 may also include a tail boom pitch angle β measured from a vertical axis 119 of the aircraft to the chord 117. The vertical axis 119 may lie entirely within the plane P2 (or a plane parallel thereto), according to some embodiments. The aerodynamic apparent angle of attack α may be used to calculate a lift curve as described below.

According to some embodiments, the aerodynamic apparent angle of attack α of the tail boom 150 increases when an aircraft that is in hover (as shown in FIG. 14) is affected by a crosswind (e.g., when the air flow direction approaches the tail boom 150 from the approaching side 114 as shown in FIG. 15). As shown, the tail boom 150 may be shaped such that when the aerodynamic apparent angle of attack α is beyond the maximum lift capability of the tail boom 150 the airflow becomes “separated” from a surface of the tail boom 150. This airflow separation eliminates the accelerated, low pressure, zone on the surface of the tail boom 150, thereby reducing a pressure differential across the tail boom 150, and as a result reducing the required rudder pedal input (tail rotor thrust) by the pilot of the aircraft.

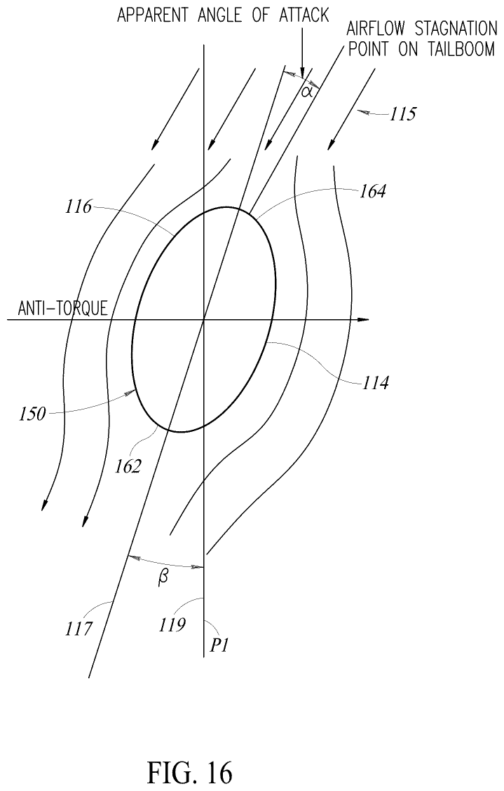

As shown in FIG. 16, when the aircraft is affected by a crosswind coming from the retreating side 116 of the aircraft the tail boom 150 generates beneficial anti-torque that lowers the maximum rudder pedal input at the critical azimuth. The tail boom shape will create beneficial anti-torque up to the maximum desired crosswind which would depict the apparent angle of attack where the coefficient of lift C_{L} is zero. Although shown as a simple oval shape in the illustrated embodiments, the tail boom 150 as described herein is not limited to that particular shape.

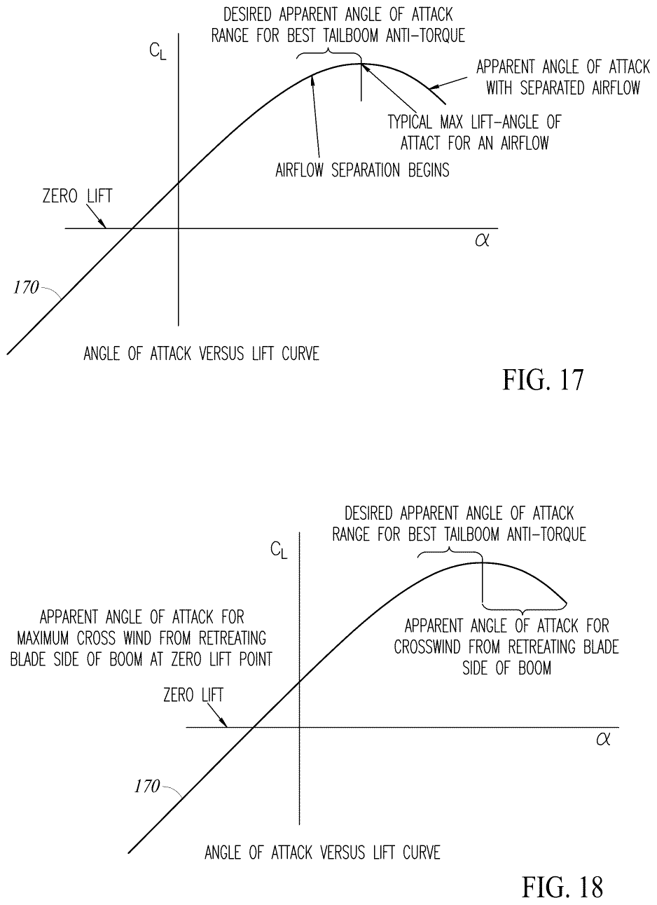

Referring to FIGS. 17 and 18, aerodynamic shapes have a “Lift Curve” that illustrates the relationship of the aerodynamic force generated as a function of the direction of airflow over the surface of the shape. In general, a Lift Curve charts the coefficient of lift (C_{L}) relative to the aerodynamic apparent angle of attack α for a given chord 117. As shown in the illustrated embodiment, a Lift Curve 170 for the tail boom 150 may be used to improve hover and crosswind performance of an aircraft to which the tail boom 150 is attached. The maximum beneficial anti-torque to be produced by the tail boom 150 will occur when the shape of the tail boom 150 generates a maximum stable coefficient of lift C_{L} for the aerodynamic apparent angle of attack α in the hover condition. As the aerodynamic apparent angle of attack α increases with increasing crosswind from the approaching side 114 of the tail boom 150, the coefficient of lift C_{L} begins to decline below its maximum and into a region of airflow separation on the low pressure side of the tail boom 150.

The airflow separation eliminates the low pressure generated on the retreating blade side of the tail boom. This offsets an increase in pressure caused by the crosswind impinging on the approaching side of the tail boom. The separation of flow reduces the anti-torque generated by the crosswind impinging on the tail boom. If this flow did not separate, the crosswind impingement on the tail boom would be larger than the tail rotor can offset in the opposite direction. As the aerodynamic apparent angle of attack α decreases with increasing crosswind from the retreating side of the tail boom 150 the coefficient of lift C_{L} declines.

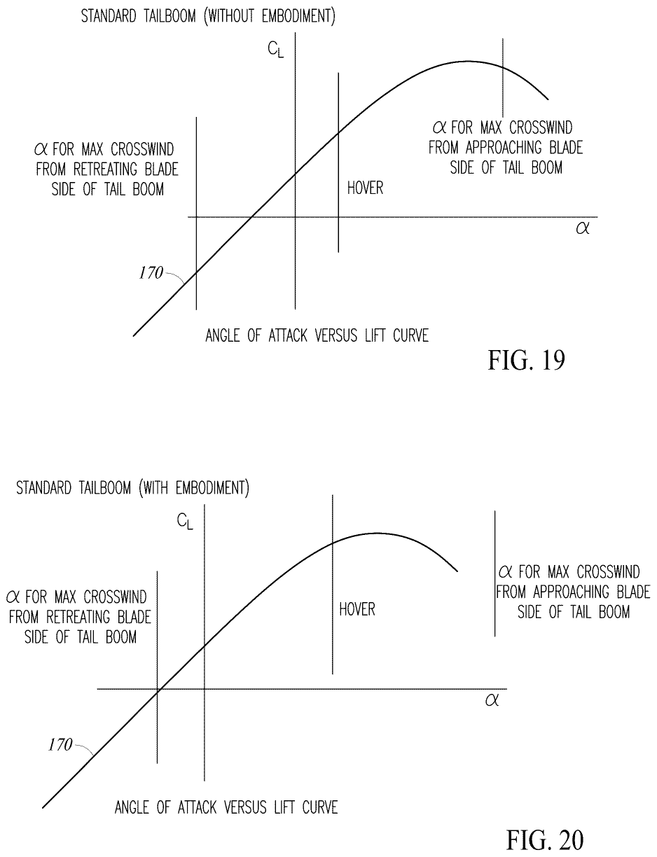

Referring to FIGS. 19 and 20 the hover and the max crosswind points on the lift curve 170 are shown for a known tail boom (FIG. 19) and the tail boom 150 (FIG. 20). As shown in FIG. 19, the known tail boom does not provide the maximum coefficient of lift C_{L} for a hover condition, and the coefficient of lift C_{L} is negative for a maximum crosswind from the retreating blade side. Additionally, the flow has not separated for maximum crosswind from the approaching blade side. Each of these three effects reduces the potential aerodynamic benefit of the tail boom. As shown in FIG. 20, the tail boom 150 shifts the hover point on the lift curve so that the tail boom 150 is producing more lift in hover the hover condition. Additionally, the coefficient of lift C_{L} is not negative for a maximum desired crosswind from the retreating blade side and the flow has separated for a maximum desired crosswind from the approaching blade side.

While shown in the illustrated embodiments with a symmetrical shape, the tail boom 150 may be further optimized (e.g., to include a non-symmetrical shape) to tailor the lift curve to maximize the hover anti-torque, where the coefficient of lift C_{L} becomes negative for the desired crosswind from the retreating blade side, and when the flow has separated for the desired crosswind from the approaching blade side.

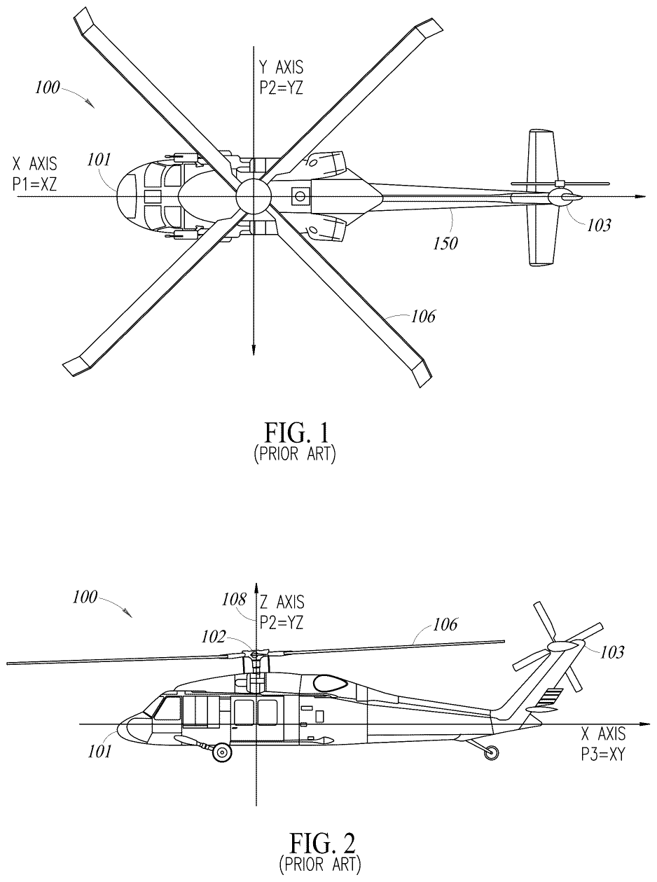

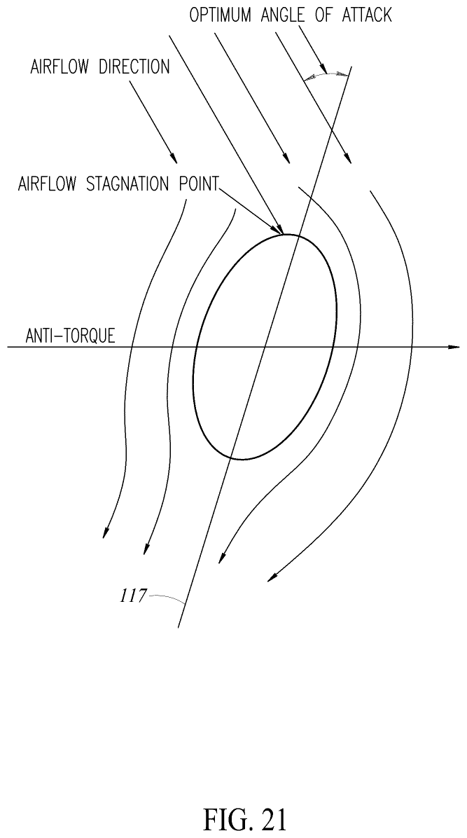

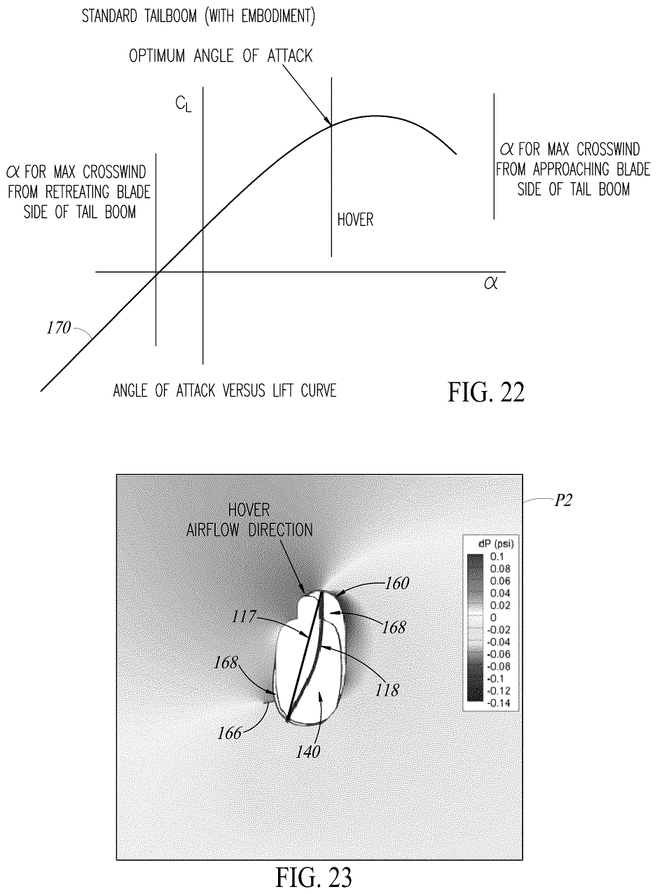

Referring to FIGS. 1 to 22, some embodiments of the tail boom 150 include a shape (e.g., an upper surface, a leading edge, a cross-sectional perimeter), that maintains directional control for the aircraft 100 in up to the desired crosswind in all directions (e.g., from any direction within the 360 degree perimeter 122). Industry regulatory requirements define the minimum required crosswind demonstrated capability is 17 kts. The cross-sectional perimeter may be a shape that lies within the plane P2 (or a plane parallel to the plane P2). According to some embodiments, the cross-sectional perimeter may be formed by a body of the tail boom. The body of the tail boom may be monolithic such that it does not include any strakes, spoilers, fairings, or other projections from an external surface of the body of the tail boom. Alternatively, in the case of a retrofit, the cross-sectional perimeter of the tail boom 150 may include one or more fairings, strakes and vortex generators coupled (e.g., permanently) to a pre-existing tail boom.

The chord 117 of the tail boom 150 may be shaped to maximize the coefficient of lift C_{L} for the anti-torque generated by the tail boom 150 when the aircraft 100 is hovering (e.g., such that the aerodynamic apparent angle of attack α is determined by the aerodynamics of the main rotor 102). Similar to the cross-sectional perimeter of the tail boom 150, the chord 117 may be based on the body of the tail boom 150 excluding any strakes, spoilers, and/or fairings). Alternatively, in the case of a retrofit, chord 117 of the tail boom 150 may include one or more fairings, strakes and vortex generators coupled (e.g., permanently) to a pre-existing tail boom.

The chord 117 may be shaped to produce the coefficient of lift C_{L} that augments the tail rotor 110 to produce a sufficient amount of anti-torque to maintain directional control when the aircraft 100 is impacted by the maximum amplitude of crosswind within the operational range (e.g., up to 17 kts) from the retreating side 116 of the tail boom 150. The aerodynamic apparent angle of attack α for this condition is the sum of the crosswind and the aerodynamics of the main rotor 102. The crosswind acts on the aircraft 100 to turn the aircraft 100 into the wind. The anti-torque needed to resist this turning of the aircraft 100 is the sum of the torque generated by the main rotor 102 and the aerodynamic torque generated by the crosswind acting on the aircraft 100.

Some embodiments of the tail boom 150 may be shaped to create separated airflow, causing a drop off of anti-torque as the crosswind increases from the approaching side 114 of the tail boom 150. The aerodynamic apparent angle of attack α for this condition is also the sum of the crosswind and the aerodynamics of the main rotor 102. The anti-torque needed to maintain directional control of the aircraft 100 is the sum of the torque of the main rotor 102 and the aerodynamic torque caused by the crosswind acting on the aircraft 100.

Autorotation, where the airflow over the tail boom is an upwash, is countered by anti-torque applied in the opposite direction (compared to anti-torque applied when hovering). This results in a low pressure zone being present on opposite sides of the tail boom 150 depending on the flight condition of the aircraft 100. The chord 117 may be shaped to provide anti-torque in both the forward and the descending flight conditions. The aerodynamic shape of a lower surface 162 may generate a stable anti-torque when variable crosswinds are encountered by the aircraft 100. Thus, embodiments of the tail boom 150 may be devoid of a traditional airfoil trailing edge and instead include a leading edge radius to result in a larger variation of angle of attack.

Some embodiments of the tail boom 150 are shaped such that during forward flight airflow transition from a downwash to a horizontal flow, the tail boom produces minimum profile and parasitic drag. Forward facing and aft facing surfaces of the tail boom 150 may be faired into the existing airframe to preclude an increase in cruise drag.

Referring to FIGS. 14 to 16, some embodiments of the tail boom 150 may be shaped (e.g., using known wing design theory) to have an upper surface 164 that has a rounded shape typical of low speed wing leading edges that are conducive to a wide range of angle of attack. When applied to the tail boom 150, this large angle of attack created by the large range of crosswind/airflow generates a higher velocity and corresponding lower pressure over the retreating side 116 of the tail boom 150. The shape of the tail boom 150 may be designed specifically to address the direction of the airflow from downwash of the main rotor 102, or downwash angle of attack, in hover conditions as well as the combined downwash from the main rotor 102 and the maximum operable wind speed (e.g., 17 kts) approaching from within the critical wind azimuth zone 124.

The shape of the tail boom 150, specifically the shape and position of the leading edge, may change to correspond to different down wash angles of attack and maximum desired crosswinds. In particular, the stagnation point of the airflow in hover may be designed to correspond to the optimum coefficient of lift C_{L} for the lift curve. The shape of the tail boom 150 can be further adjusted to change camber or surface profile to cause the lift curve to change the zero lift point so it is as close as possible to the desired maximum crosswind from the critical wind azimuth zone 124.

Disclosed herein is a process to design and select a shape of the tail boom 150. The shape may be adjusted until a maximum amount of coefficient of lift C_{L} is achieved when the aircraft 100 is hovering. The selected shape may produce sufficient anti-torque to counter the torque of the main rotor 102 before the airflow on the low pressure side of the tail boom 150 begins to separate from the surface thereby reducing the produced anti-torque.

Disclosed herein are methods of modifying an existing tail boom (e.g., the known tail boom 140) to have a shape of the tail boom 160 as described herein. According to some embodiments of the method, the existing shape of the known tail boom 140 influences the shape of the modified tail boom 160. The method may include removing strakes 166 and/or fairings 168 that were attached to the existing tail boom. Additionally, the method may include attaching one or more strakes 166, one or more fairings 168, or one or more strakes 166 and one or more fairings 168 to the modified tail boom 160. Aerodynamic analysis tools may be utilized to calculate possible options for the shape of the modified tail boom 160, including an anti-torque versus angle of attack analysis to determine if the options for the shape are within a desired angle of attack region. If it is determined that one or more of the options for the shape of the tail boom 160 are not within the desired angle of attack region, the shape may be adjusted and the analysis repeated on the adjusted shape.

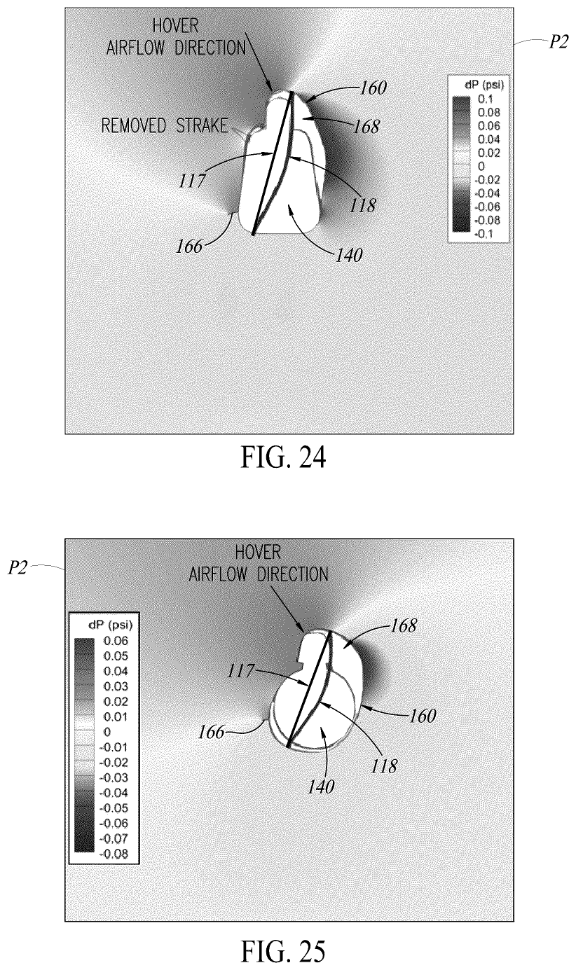

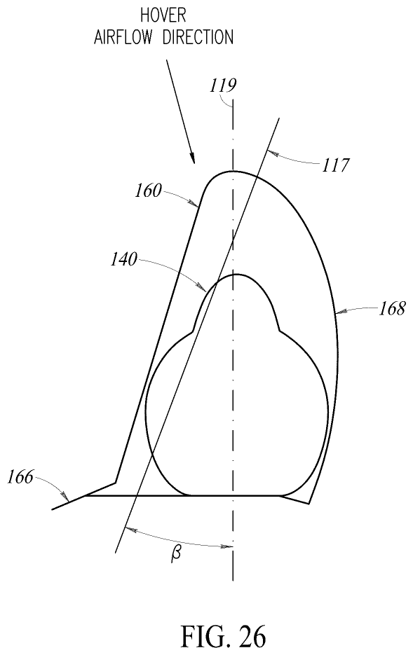

Examples of the method of converting the known tail booms 140 into the tail booms 160 are shown in FIGS. 23 to 26. Different known shapes for the known tail boom 140 (e.g., oval as shown in FIG. 23, trapezoidal as shown in FIG. 24, and round as shown in FIG. 25) are shown with corresponding modifications to the tail boom 160 in the computational fluid dynamics analysis provided in FIGS. 23 to 25. The tail boom 160 may define a camber line 118 that intersects the leading edge and the trailing edge (e.g., starts and stops at the chord 117), and defines a path halfway between the opposite surfaces of the tail boom 160. As shown, the camber line 118 may curve away from the chord 117 proximate the leading edge and curve toward the chord 117 proximate the trailing edge. Once again, the method is not limited to the specific shapes of the known tail booms 140 or the modified tail booms 160, shown in the illustrated embodiments. Converting the known tail booms 140 to the tail booms 160 may include removal of one or more strakes (e.g., as shown in FIG. 24). Similarly, converting the known tail booms 140 to the tail booms 160 may include addition of one or more strakes (e.g., as shown in FIG. 26).

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The various embodiments described above can be combined to provide further embodiments.

Many of the methods described herein can be performed with variations. For example, many of the methods may include additional acts, omit some acts, and/or perform acts in a different order than as illustrated or described.

The embodiments, features, systems, devices, materials, methods and techniques described herein may, in certain embodiments, be applied to or used in connection with any one or more of the embodiments, features, systems, devices, materials, methods and techniques disclosed in the above-mentioned U.S. Provisional Ser. No. 63/724,174 and is hereby incorporated by reference herein. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A tail boom for an aircraft, the tail boom comprising:
a cross-sectional shape formed by an outer perimeter of a body of the tail boom within a first plane, wherein the cross-sectional shape includes a chord,
wherein the tail boom is mounted to the aircraft such that a chord of the cross-sectional shape is angularly offset from a second plane that: 1) is parallel to and intersects an axis of rotation of a main rotor of the aircraft about which one or more main rotor blades rotate to generate lift for the aircraft; and 2) is perpendicular to the first plane.

2. The tail boom of claim 1 wherein the tail boom is elongate along an axis that lies within the second plane.

3. The tail boom of claim 1 wherein the chord is angularly offset from the second plane in a range between 5 degrees and 20 degrees.

4. The tail boom of claim 1, further comprising an upper surface with a rounded shape.

5. The tail boom of claim 4 wherein the rounded shape of the upper surface has a radius of curvature with a stagnation point of the main rotor downwash in a hover condition that corresponds to a maximum value for a coefficient of lift for the hover downwash angle of attack.

6. The tail boom of claim 4 wherein the intersection of the chord and the upper surface is offset from an intersection of the second plane and the upper surface.

7. The tail boom of claim 4, further comprising a lower surface with a rounded shape, wherein the lower surface is opposite the upper surface with respect to the chord.

8. The tail boom of claim 7 wherein an intersection of the chord and the lower surface is angularly offset from the second plane.

9. The tail boom of claim 1, further comprising a strake extending from an outer surface of the body of the tail boom that forms the cross-sectional shape and influencing the aerodynamic shape.

10. An aircraft comprising:
a main rotor that rotates about a first axis of rotation to rotate one or more main rotor blades to generate lift for the aircraft;
a tail rotor that rotates about a second axis of rotation to rotate one or more tail rotor blades to generate thrust that counters torque generated by the rotation of the main rotor about the first axis of rotation; and
the tail boom of claim 1 positioned between the main rotor and the tail rotor.

11. A method of retrofitting a tail boom of an aircraft, the method comprising:
changing a cross-sectional shape of the tail boom formed by an outer perimeter of a body of the tail boom within a first plane, thereby altering a chord of the tail boom such that when the tail boom is mounted to the aircraft the altered chord is angularly offset from a second plane that: 1) is parallel to and intersects an axis of rotation of a main rotor of the aircraft about which one or more main rotor blades rotate to generate lift for the aircraft; and 2) is perpendicular to the first plane.

12. The method of claim 11, further comprising:
adding a fairing to the tail boom to change the cross-sectional shape of the tail boom.

13. The method of claim 12, further comprising:
adding a first portion of the fairing to an approaching side of the tail boom;
adding a second portion of the fairing to a retreating side of the tail boom; or
adding the first portion of the fairing to the approaching side of the tail boom and adding the second portion of the fairing to the retreating side of the tail boom.

14. The method of claim 12, further comprising:
adding a portion of the fairing to change an upper surface shape of the tail boom such that the altered chord is angularly offset from the second plane.

15. The method of claim 14, further comprising:
adding a portion of the fairing to change a location of a lower edge of the tail boom such the altered chord is angularly offset from the second plane.

16. The method of claim 15 wherein the altered chord intersects the second plane at a location between the intersection of the altered chord and the upper surface and the intersection of the altered chord and the lower edge.

17. The method of claim 12, further comprising:
adding a strake to the fairing.

18. The method of claim 16 wherein the chord is altered based on the achieved lift curve of the tail boom shape and to result in a desired cross wind capability for the aircraft.
